(19) United States
(12) Patent Application Publication
(10) Pub. No.: US 2012/0022984 A1
(43) Pub. Date: Jan. 26, 2012

(54) TOOL FOR CALCULATING TAX CREDIT AMOUNT AND ELIGIBILITY

(76) Inventor: Timothy J. MORRISON, Mechanicsburg, PA (US)

(21) Appl. No.: 13/186,547

(22) Filed: Jul. 20, 2011

Related U.S. Application Data
(60) Provisional application No. 61/366,386, filed on Jul. 21, 2010.

(51) Int. Cl. G06Q 40/00

(52) U.S. Cl. 705/31

(57) ABSTRACT

An online web-based software application is disclosed to calculate the exact amount of tax credit that a business may receive under the Small Business Tax Credit under Section 45R of the Internal Revenue Code, Title 26 of the United States Code, based on the state each employee works and health care coverage provided by the business to its employees. In one embodiment, a system for determining a healthcare tax credit using a web-based healthcare tax credit calculating tool is disclosed. The healthcare tax credit calculating tool resides on a web server and is accessible from a remote device by a user or users over a wide area network.

### CROSS-REFERENCE TO RELATED APPLICATIONS

This application claims the benefit of U.S. Provisional Application No. 61/366,386, entitled “TOOL FOR CALCULATING TAX CREDIT AMOUNT AND ELIGIBILITY” filed Jul. 21, 2010, which application is hereby incorporated by reference in its entirety.

### FIELD OF THE INVENTION

The present invention is directed to computer-based systems for calculating tax credits. More specifically, the present invention relates to an online web-based software application for determining a Small Business Tax Credit under Section 45R of the Internal Revenue Code and eligibility therefor, for a qualifying small business.

### BACKGROUND OF THE INVENTION

There are currently many “estimator” calculation tools available on the Internet today for calculating a healthcare tax credit. The majority of calculators typically ask for several items of data, for example, the number of full-time equivalents (FTEs), amount of employer paid healthcare premiums, and a company's status under the IRC as “for profit” or “tax exempt”. Currently all available tax credit calculators fail to take into account the majority of information required in order to create a correct calculation for any specific company or client. By not taking into consideration all the factors necessary to provide an accurate calculation detailed under the law, the output generated by these existing calculators are mere estimates at best, and are not sufficiently accurate to be entered on Internal Revenue Service (IRS) Form 8941 (Form 8941) required to claim the credit on a company's business tax return.

Examples of websites with tax calculators currently available online include: http://www.cose.org; http://www.nfib.com; http://www.jlbghealth.com; and https://www.capbluecross.com. Even accounting software packages now have data entry sheets to calculate the small business tax credit (see FIG. 3), however they greatly fall short of instructions and capabilities to accurately determine FTE count and qualifying premium percentages compared to State Average Premium calculation.

There are many items necessary to produce an accurate calculation of the healthcare tax credit, clarified in IRS Notices 2010-13, 2010-44, 2010-82 and the Form 8941 instructions that have not been taken into account in the above websites and accounting software calculator tools. Examples of items not included in their calculations are:

1. For the very few of the web links that factor the State Average Premium into the equation, none correctly compare the individual percentage of premium paid to use the correct percentage of State Average Premium nor do they allow for usage of State Average Premium for multiple states that each employee performs work for the employer. Notice 2010-13 published by the Department of Revenue sets forth the average premium for each state (State Average Premium) for use in the calculation of each employer's tax credit calculation depending upon which state the employer is registered and doing business.

2. How to accurately calculate FTE counts using hours, days or weeks to optimize the credit for the small business when factoring the average wage and employees in excess of “10” credit reductions.

3. The fact that each employee's benefits must be analyzed individually then compared to the State Average Premium of the state in which they work for their specific coverage. An employer may have employees working in multiple states and each State Average Premium is different depending on where the employee works.

4. The option for each employer to use hours worked, days worked or weeks worked to determine which method would produce the optimal FTE count with corresponding credit reductions to optimize a company's Tax Credit.

5. Single or Family State Average Premium must be used individually for each employee dependent upon whether they have Single or Family qualifying coverage for either Medical, Dental, Vision or Extra Qualifying coverage and what state they actually work in.

6. The fact that State Premium Credits or Subsidies must be factored into the calculation of the tax credit.

7. A tool that transfers the pertinent data from the calculation to a sample Form 8941 in the required entry in Lines 1 through 14 on Form 8941.

There is a need for a tool that small businesses and accountants can use to accurately calculate the healthcare tax credit amount.

### SUMMARY OF THE INVENTION

An online web-based software application is disclosed to calculate the exact, optimal amount of tax credit that a business may receive under the Small Business Tax Credit under Section 45R of the Internal Revenue Code, Title 26 of the United States Code, based on the State Average Premium for each employee depending on what state they work and qualifying healthcare coverage provided by the business to its employees in each state.

In one embodiment, a system for determining a healthcare tax credit is disclosed. The healthcare tax credit calculating tool resides on a web server and is accessible from a remote device by a user or users over a wide area network. The healthcare tax credit calculating tool is configured to perform the steps of: determining a State Average Premium to determine a number of non-excludable employees from a plurality of employees; determine a total of wages for a total number of non-excludable employees; identify at least one qualifying healthcare coverage applicable for each non-excludable employee; calculate a number of FTEs worked during a tax year by the non-excludable employees and generate a template configured for the number of FTEs. For each non-excludable employee enter identifying data associated with each non-excludable employee and determine a qualifying healthcare coverage associated with the respective non-excludable employee. For each qualifying healthcare coverage that is identified for the non-excludable employee enter a total annual amount of qualifying healthcare coverage premium paid for the qualifying healthcare coverage during the tax year and enter the total annual amount of qualifying healthcare coverage premium paid by the respective non-excludable employee during the tax year. If the non-excludable employee data indicates all Single coverage for all benefits, then apply a “Single State Average premium” for their specific state for where that specific non-excludable employee works. If the non-excludable employee data includes at least one healthcare coverage other than single selected from one of non-excludable employee and child, non-excludable employee and children, non-excludable employee and spouse, or family, apply a “Family State Average Premium”. If the respective non-excludable employee has waived all available employer-provided healthcare coverage, apply only the non-excludable employee's salary and hours, days or weeks in determining one of the two healthcare credit reductions, if any, compute an FTE in excess of 10 credit reduction; compute an average wages credit reduction; calculate a first tax credit reduction for FTEs in excess of 10; calculate a second healthcare tax credit reduction; and determine a net healthcare tax credit.

In another embodiment, a method of determining a healthcare tax credit is disclosed. The healthcare tax credit calculating tool resides on a web server and is accessible from a remote device by a user or users over a wide area network. The healthcare tax credit calculating tool is configured to perform the steps of: determining a State Average Premium based on a state of the United States in which each employee is employed; to determine a number of non-excludable employees from a plurality of employees; determine a total of wages or non-excludable employees; identifying at least one type of qualifying healthcare coverage applicable for each non-excludable employee from one or more of the following qualifying healthcare coverages: Medical, Dental, Vision and/or Extra Qualifying Coverage or waived coverage; calculate a number of FTEs using hours, days or weeks worked during a tax year of non-excludable employees and generate a template configured for the number of FTEs. For each non-excludable employee enter identifying data associated with each non-excludable employee and determine a qualifying healthcare coverage or waived option associated with the respective non-excludable employee. For each qualifying healthcare coverage that is identified for the non-excludable employee will enter a total annual amount of premium paid for the qualifying healthcare coverage during the tax year and enter the total annual amount of premium paid by the respective non-excludable employee during the tax year, for each qualifying healthcare option associated with the respective employee. If the non-excludable employee data indicates all Single coverage for all benefits, then applying a “Single State Average premium” for their specific state for where that specific non-excludable employee works. If the non-excludable employee data includes at least one qualifying healthcare coverage other than single selected from one of non-excludable employee and child, non-excludable employee and children, non-excludable employee and spouse, or family, applying a “Family State Average Premium”. If the respective non-excludable employee has waived all available employer-provided healthcare coverage, applying only the employee's salary and hours, days or weeks in determining one of the two healthcare credit reductions, if any, applying an optimal number of FTEs using hours, days or weeks (rounded down to lower whole number) to compute an FTE in excess of 10 credit reduction; applying an optimal number of FTEs using hours, days or weeks to average wages (rounded down to the next 1,000) to compute an average wages credit reduction; determining a first tax credit reduction for FTEs in excess of 10; calculate a second healthcare tax credit reduction comprising totaling average wages for all employees and dividing the total average wages by the number of FTEs; and determining a net healthcare tax credit by subtracting the first tax credit reduction and the second healthcare tax credit reduction from a gross healthcare tax credit, creating a sample Form 8941 for ease in transference of data from the calculation to the proper entries in Lines 1 through 14 of Form 8941.

In another embodiment, a healthcare tax credit calculating tool, the tool is disclosed. The healthcare tax credit calculating tool is configured to determine a State Average Premium; determine a number of non-excludable employees from a plurality of employees; determine a total of wages for a total number of non-excludable employees; identify at least one qualifying healthcare coverage applicable for each non-excludable employee, calculate a number of full time equivalents worked during a tax year by the non-excludable employees; generate a template configured for the number of full time equivalents. For each non-excludable employee; enter identifying data associated with each non-excludable employee and determine a qualifying healthcare coverage associated with the respective non-excludable employee. For each qualifying healthcare coverage that is identified for the non-excludable employee, enter a total annual amount of qualifying healthcare coverage premium paid for the qualifying healthcare coverage during the tax year; and enter the total annual amount of qualifying healthcare coverage premium paid by the respective non-excludable employee during the tax year. If the non-excludable employee data indicates all Single coverage for all benefits then apply a “Single State Average premium” for their specific state for where that specific non-excludable employee works. If the non-excludable employee data includes at least one healthcare coverage other than single selected from one of non-excludable employee and child, non-excludable employee and children, non-excludable employee and spouse, or family, apply a “Family State Average Premium”; or if the respective non-excludable employee has waived all available employer-provided healthcare coverage, apply only the non-excludable employee's salary and hours, days or weeks in determining one of the two healthcare credit reductions, if any, compute an FTE in excess of 10 credit reduction compute an average wages credit reduction calculate a first tax credit reduction for FTEs in excess of 10; calculate a second healthcare tax credit reduction; and determine a net healthcare tax credit.

The disclosed invention allows small businesses to take advantage of a tax credit available to them without spending many hours sifting through the tax regulation maze. Accordingly, Form 8941 instructions list, it estimates 16 hours and 57 minutes for recordkeeping, learning about the law and preparation of IRS forms (see, e.g., IRS Instructions for Form 8941: Credit for Small Employer Health Insurance Premiums 2010, which is incorporated by reference). Rather than spending exorbitant time and frustration with regulations, the disclosed invention offers the ability to perform an accurate calculation in minutes versus 16+ hours.

Further, the disclosed invention eliminates or reduces the inconvenience and downtime associated with researching complicated regulations to determine if companies qualify for the Small Business Tax Credit. There are many different variables per each individual employee along with specific State domicile utilized in order to produce a correct calculation. The invention also selects the data from the optimal tax credit for a small business and produces a sample Form 8941 completing necessary data in Lines 1 through 14 to assist the tax preparer with the filing of this required form on the small businesses to claim the credit.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows an exemplary worksheet table containing the healthcare tax credit calculations that the web based calculator tool is based upon.

FIGS. 1A through 1D show enlarged sections of FIG. 1

FIGS. 2A and 2B show an exemplary data entry worksheet for multiple users.

FIG. 3 is a sample Form 8941 prepared from the system.

FIG. 4 is a flow chart showing an exemplary embodiment of the method of calculating a small business healthcare tax credit.

### DETAILED DESCRIPTION OF THE INVENTION

The United States Internal Revenue Service, Department of Labor, and Department of Health and Human Services have published very, very complex requirements and formulas for businesses to use to calculate a small business tax credit for healthcare benefits that the respective business provides to its employees. The initial “Patient Protection and Affordable Care Act” (PPACA, H.R. 3590) bill signed into law on Mar. 23, 2010, then the Reconciliation bill (H.R. 4872) was signed into law on Mar. 30, 2010 and Section 45R of these bills announced a tax credit for employee health insurance expenses of small employers (“healthcare credit”).

While the disclosed embodiment of the healthcare credit calculator is released given current 2010 regulations, any further information or regulatory releases may be updated in the healthcare credit calculator for a company's actual, final calculation that would be required for 2011 through 2017. The healthcare credit is available for small businesses for tax years beginning after Dec. 31, 2009.

The healthcare credit is generally available to small business employers that pay at least half the cost of single coverage of a “qualifying arrangement” health care plan(s) for their employees. A qualifying small business is defined as a business with twenty-five or fewer FTE employees and average annual wages of less than $50,000. However, companies with as many as 100 employees may qualify depending on hours worked by each employee and the healthcare credit calculator tool is configured to assist companies to determine if they would qualify.

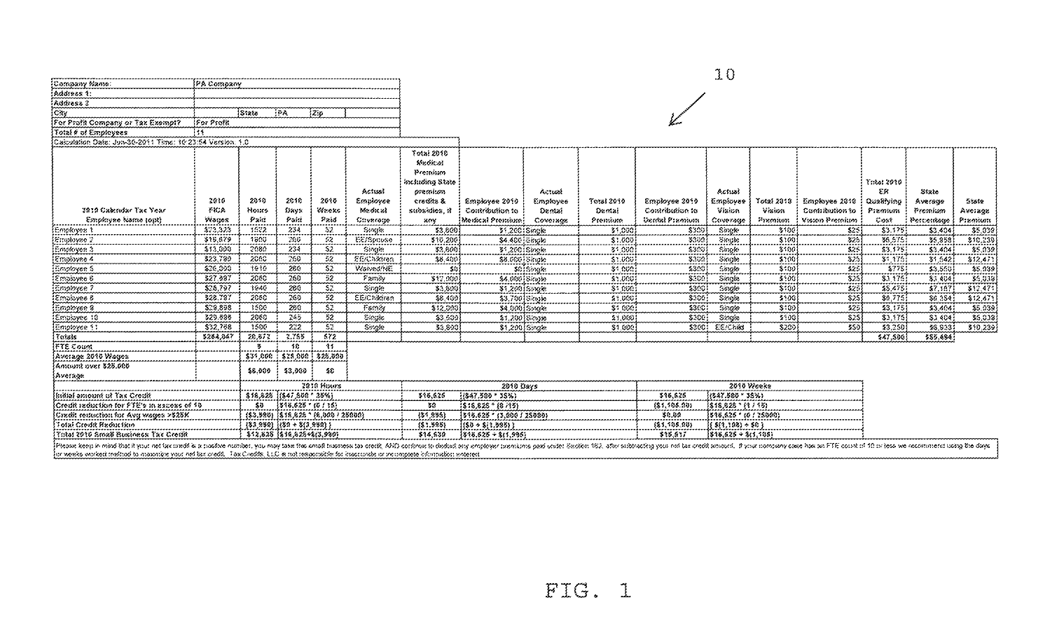

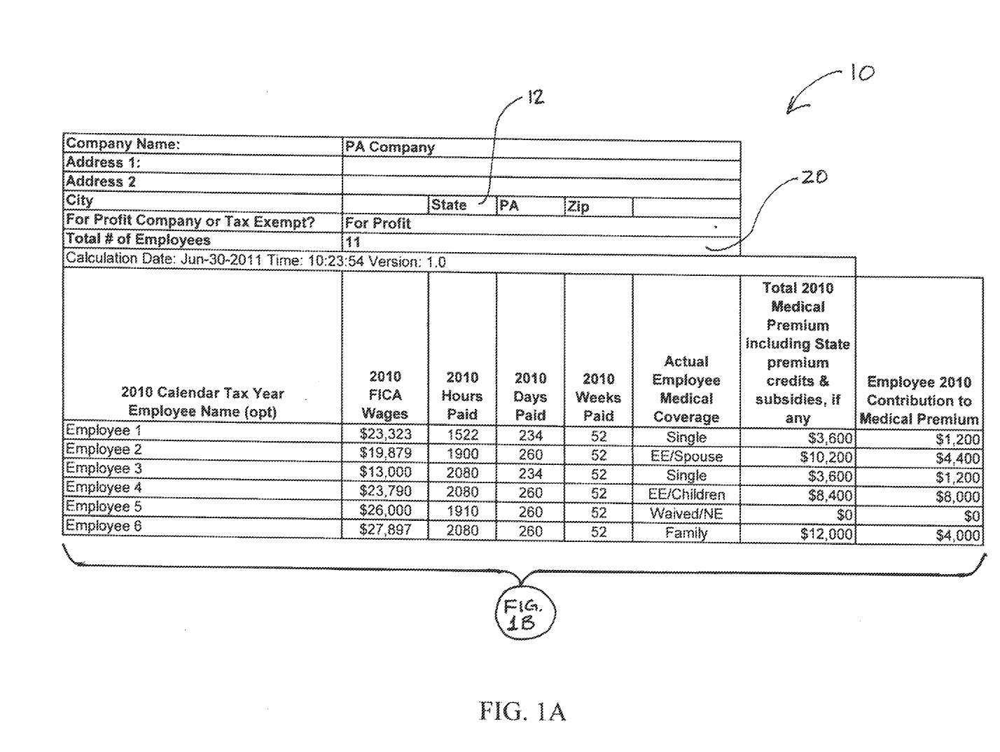

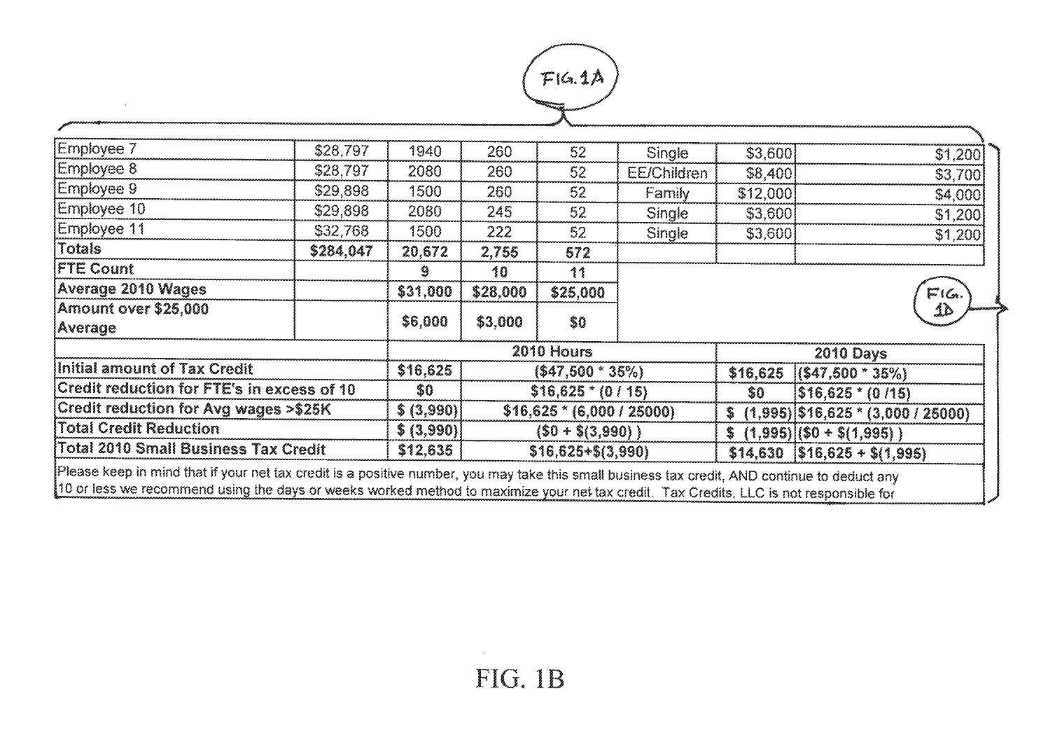

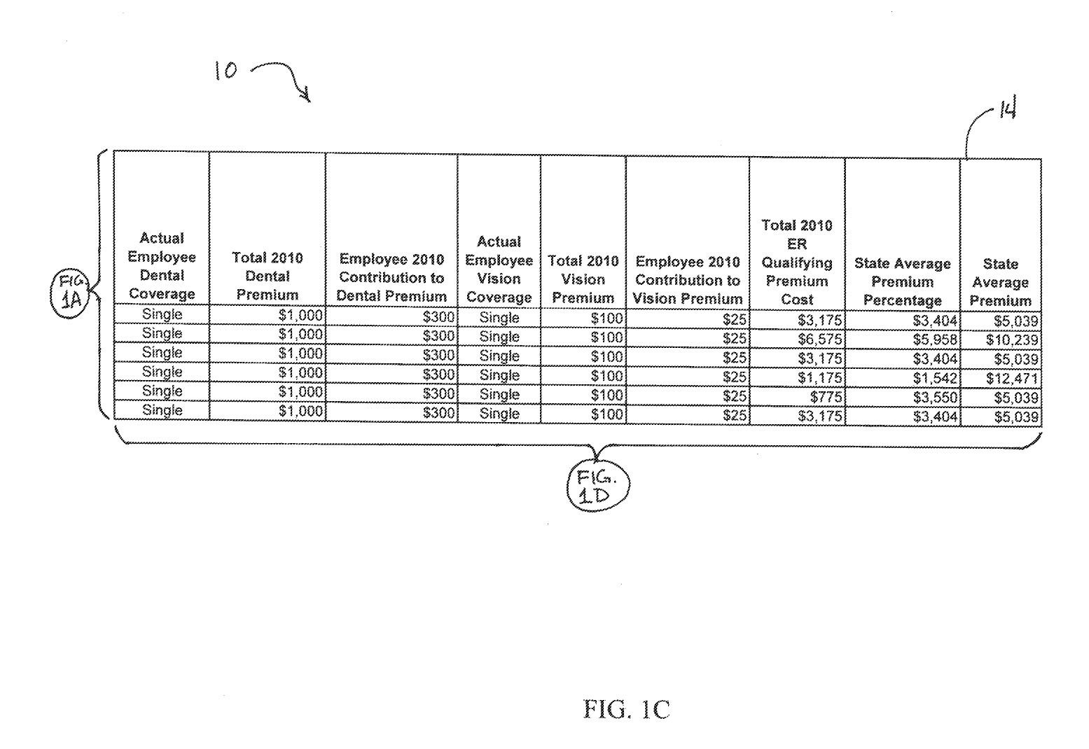

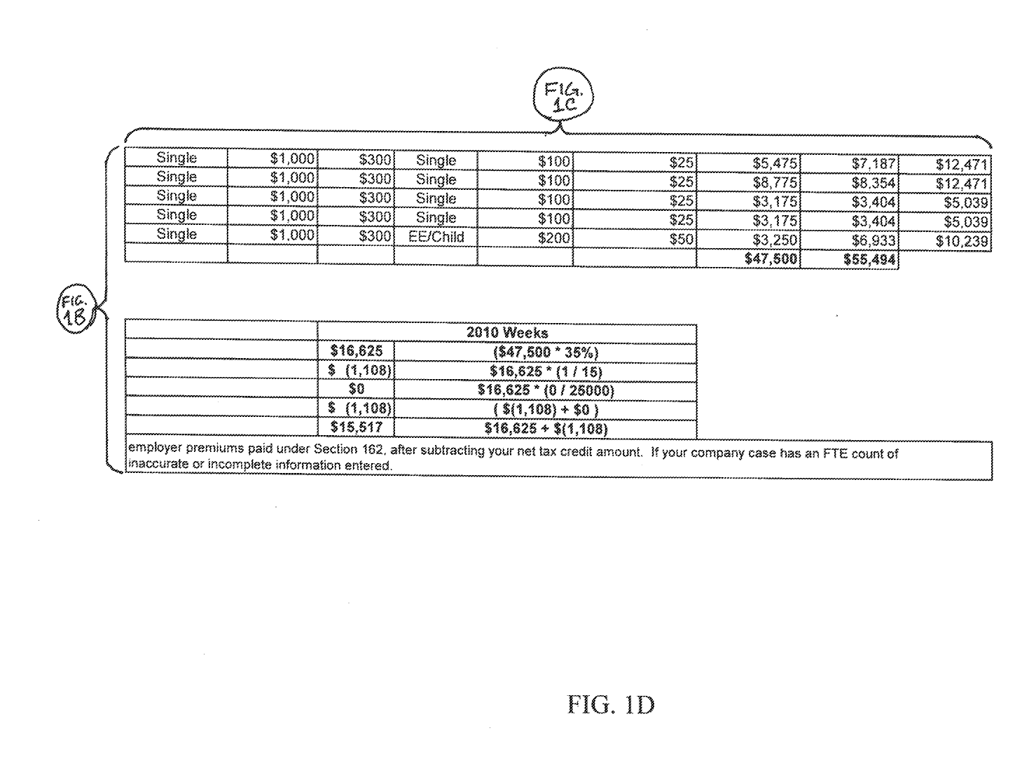

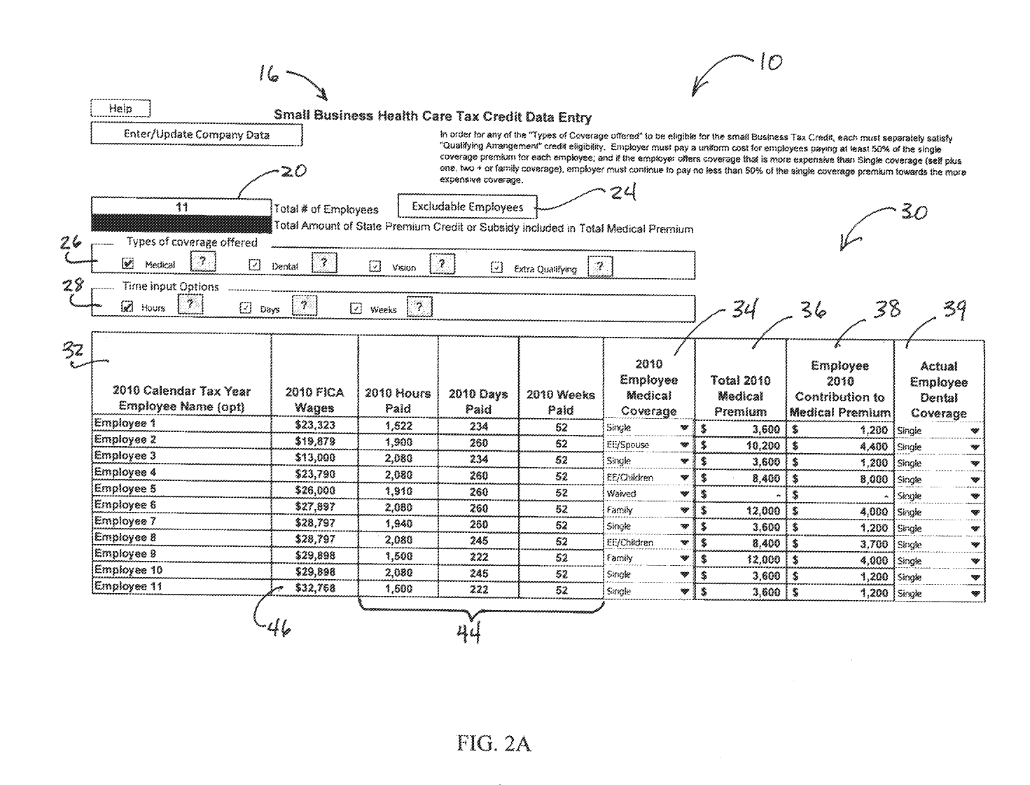

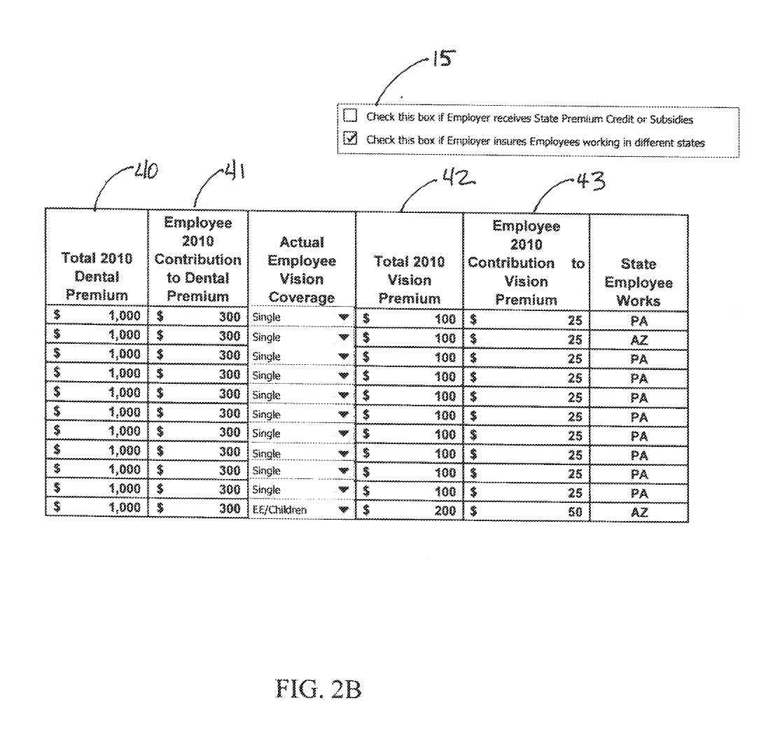

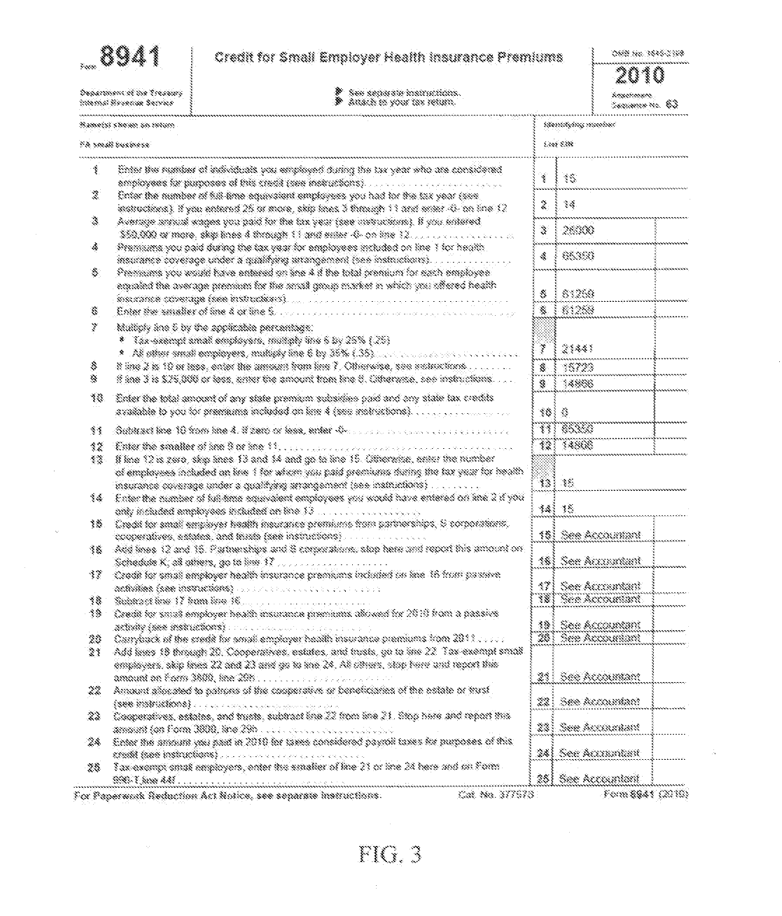

Referring to FIG. 1, FIGS. 1A through 1D and FIGS. 2A and 2B, the calculator tool includes all required variables in a data format entry form to produce an accurate calculation for a business. The method of calculating the healthcare benefit, e.g., through a web interface software module, is implemented as follows:

1. At a user interface, a calculator tool 10, e.g., a web browser displayed on a computer monitor, the user selects a single state of domicile 12 wherein the employer conducts business or selects multiple states if they have employees working in multiple states to determine which State Average Premium 14, as issued by the Internal Revenue Service, must be applied in calculating the healthcare credit. The State Average Premium table is revised by the Department of Revenue annually, requiring an updated table for a State average premium. If multiple states are selected then the option to select the individual state that each employee works is provided on the data entry sheet.

2. The user may also select a check box if they receive State Premium Credits or Subsidies towards their cost of qualified coverages. By selecting this option, they are prompted to enter the total amount of credits or subsidies they received during a tax year, which must be used in the calculation of the tax credit. This information is also required on the Form 8941 as in no event may an employer's small business tax credit (Section 45R credit) exceed the amount of the employer's net premium payments.

3. The calculator tool 10 displays the specific language 16 from the statute or regulation that “excluded” employees and owners' wages, hours, and health insurance premiums paid are disregarded in determining the healthcare tax credit calculation (see, e.g. FIG. 2). Specifically, partners, sole proprietors, and shareholders owning more than 2% of an S Corporation, and any owners of more than 5% of other businesses are excluded when determining the healthcare tax credit calculation. Family members of owners and partners are also excluded. Excluded family members are further defined in Section 45R as a child or descendant of a child; a sibling or step-sibling; a parent or ancestor of a parent; a step-parent; a niece or nephew; an aunt or uncle; a son-in-law; daughter-in-law; father-in-law, mother-in-law; brother-in-law, or sister-in-law. In addition, any other member of the household of these owners or partners that qualifies as a dependent under IRC Section 152(d)(2)(H) are not taken into account as an employee for purposes of Section 45R. (footnote Notice 2010-44 Section II Part B).)

A number of excludable employees is defined upon detail button 24 according to Section 45R, and the number of excludable employees is subtracted from the total number of employees, and the user enters a number of non-excludable employees in field 20 of the healthcare credit calculator.

4. The user then checks a box 26 in calculator tool 10 corresponding to each type of healthcare coverage that is currently offered to employees that would qualify as a qualifying arrangement for the Tax Credit. The types of healthcare coverage may include Medical, Dental, Vision and/or Extra Qualifying Coverage. The employer is required to maintain a “qualifying arrangement.” A qualifying arrangement consists of the employer paying a premium for each employee for health insurance coverage in a uniform percentage (e.g., not less than 50% of Single coverage). The healthcare credit calculator tool 10 is configured to handle at least one of the four types of healthcare benefits coverage made available by an employer for employers.

5. The user may select in check boxes 28 to use one or all three of the number of days, hours or weeks worked by the respective employee, in calculating the FTEs. The healthcare credit calculator is configured to prepare the calculation based upon the optimal FTE count (comparing days, hours or weeks worked during the tax year) if the employer wishes to compare which selection (hours, weeks or days worked) provides the optimal tax credit for their company. Definitions are provided to the User regarding the number of hours, days and weeks worked by each employee, and paid days off for hours, days and weeks worked by the employee, to be included in the calculation, as follows:

a. Hours—An employee's hours of service for a year include the following: (1) each hour for which an employee is paid, or entitled to payment, for the performance of duties for the employer during the employer's taxable year; and (2) each hour for which an employee is paid, or entitled to payment, by the employer on account of a period of time during which no duties are performed due to vacation, holiday, illness, incapacity (including disability), layoff, jury duty, military duty or leave of absence (except that no more than 160 hours of service are required to be counted for an employee on account of any single continuous period during which the employee performs no duties).

b. Days—Use a days-worked equivalency whereby the employee is credited with 8 hours of service for each day for which the employee would be required to be credited with at least one hour of service under (1) each hour for which an employee is paid, or entitled to payment, for the performance of duties for the employer during the employer's taxable year; and (2) each hour for which an employee is paid, or entitled to payment, by the employer on account of a period of time during which no duties are performed due to vacation, holiday, illness, incapacity (including disability), layoff, jury duty, military duty or leave of absence.

c. Weeks—Use a weeks-worked equivalency whereby the employee is credited with 40 hours of service for each week for which the employee would be required to be credited with at least one hour of service under (1) each hour for which an employee is paid, or entitled to payment, for the performance of duties for the employer during the employer's taxable year; and (2) each hour for which an employee is paid, or entitled to payment, by the employer on account of a period of time during which no duties are performed due to vacation, holiday, illness, incapacity (including disability), layoff, jury duty, military duty or leave of absence.

6. A template 30 is then generated by tool 10 with columns requiring completion dependent upon the entries in step no. 1 through step no. 5 above and prompts for the entries. FIG. 2 shows an exemplary template 30 generated following completion of the above described steps.

7. A user must then enter identifying data in first column 32 of template 30 associated with each employee, e.g., a name or employee number, and the information associated with the current tax year, e.g., FICA wages, hours, weeks and/or days worked, for each employee.

8. The user enters the entry of whether the employee has single coverage or one of a group of family coverage options in column 34, e.g., employee plus child, employee plus children, employee plus spouse or family coverage for each eligible benefit (Medical, Dental, Vision, Extra Qualifying coverage) or if the employee has waived or is not eligible for coverage.

9. For each qualifying coverage benefit that is checked by the user, a column 36 is generated in a table format by healthcare tax credit calculator 10, requiring the user to complete the data for:
a. The total annual amount of premium paid for the benefit during the tax year must then be entered for each benefit (e.g. medical 38, dental 40, vision 42). Companies may have renewals mid tax year and monthly premiums may change so the annual premium is necessary for an accurate calculation.
b. Then the total annual amount of premium paid by the employee during the tax year must then be entered for each benefit (e.g. medical 39, dental 41, vision 43) (if single coverage is entered, the employer paid premium must equal 50% or more). Companies may have renewals mid tax year and monthly premium contribution by employees may change so the annual employee premium is necessary for an accurate calculation.

10. The healthcare tax credit calculator 10 may optionally be configured so that the user cannot save the data table unless all required data is entered or complete, as the healthcare tax credit calculator 10 requires each employee's election information for each employer-provided healthcare benefit, as well as the total annual employer contribution and total employee contribution towards each healthcare benefit.

11. Once all of the required information on the employee data table 30 is saved, the healthcare tax credit calculator 10 automatically performs several calculations and determinations. The healthcare tax credit calculator 10 identifies the type of healthcare coverage provided for each employer-provided healthcare benefit for each employee. If the employee data table indicates all Single coverage for all benefits in column 34, then the healthcare tax credit calculator 10 will default the “Single State Average premium” for their specific state for that specific employee's calculation. If an employee has at least one healthcare coverage other than single, e.g., employee and child, employee and children, employee and spouse, or family), then the “Family State Average Premium” is used as the default value for that employee's comparison. If the respective employee has waived all available employer-provided healthcare coverage, then only the employee's salary and days, weeks or hours will be included in the calculation for determination of the two healthcare credit reductions, if any, and no State average premium calculation is used for employees waiving all employer-provided healthcare coverage.

12. The healthcare tax credit calculator 10 then totals the columns 44 for hours, days or weeks worked by each respective employee, corresponding with the user selection associated with item no. 5 above. If all entries are checked and entered, then the healthcare tax credit calculator 10 computes a total for all three columns 44 and uses the number for FTEs (rounded down to the next whole number). The number of FTEs is then used in the average wages credit reduction calculation described in item no. 13 below and also in the Tax Credit reduction for FTEs in excess of “10” FTE calculation.

13. The wages column 46 is totaled and divided by the FTE whole number produced in step no. 12 and rounded down to the next $1,000. This number is then used in the tax credit reduction for Average wage exceeding $25,000 calculation.

14. The healthcare tax credit calculator 10 then looks at each individual employee to total the employer's total of premium paid for each employee's benefit, minus the total of employee contributions for each “qualified benefit(s)” that the employee has coverage. If an employee received medical, dental and vision benefits and the employer premium is $3,600 for medical (employee paid $1,200), $1,000 for dental (employee paid $300) and $100 for vision (employee paid $25), the healthcare tax credit calculator adds total employer premium paid ($4,700) and divides by the total employee premium paid ($1,525) to arrive at an Employer-paid percentage of 67.5532%. This percentage of employer contribution is then multiplied by either the Single or Family State Average premium defaulted in step no. 11 above. In this example, the current employer net premium paid is $3,175 ($4,700−$1,525) and if the State was Pennsylvania then Average Premium $5,039 is used, then the healthcare tax credit calculator 10 will compute a total State Average Premium for that employee of $3,404 ($5,039*67.5532%).

15. Each employee's total employer premium is tallied against the percentage of State Average Premium calculated in step no. 14 above and totaled. In the example set forth in FIGS. 1A-1D there are 11 employees with varying levels of coverage. The employer actual premium paid for the tax year would total $47,500. In this case the State Average Premium total would be $55,494. The healthcare tax credit calculator would use the lower of the employer paid premium or the State Average Premium totals, which in this case would be $47,500. This lower number is the number that is used to arrive at the gross Small Business Tax Credit (SBTC). For tax years beginning in 2010 the $47,500 would be multiplied by 35% if a for-profit business, to arrive at a gross healthcare tax credit of $16,625. For non-profit businesses it would be multiplied by 25%.

16. Once the gross healthcare tax credit is determined, next the healthcare tax credit reductions must be applied for FTEs over 10 and average wages over $25,000.

17. The healthcare tax credit calculator 10 looks at the total of FTEs determined in step no. 12 above. The number of FTEs in excess of 10 is used as the numerator and the total number of FTEs 15 is the denominator value prescribed by the IRS. Using the above example in step no. 16 in this example using the spreadsheet of FIG. 1, the hours-based calculation reduces our 11 employees to 9 actual FTE's (i.e., 20,672/2080=9.93 rounded down to 9) resulting in zero credit reduction for FTEs in excess of 10. The days-based calculation reduces 11 employees to 10 actual FTEs (2,755/260=10.59 rounded down to 10) resulting in zero credit reduction for FTEs in excess of 10. The weeks-based calculation results in an even 11 FTEs, same as our number of employees (572/52=11) resulting in a $1,108 credit reduction for FTEs in excess of 10. For the weeks method, the gross tax credit is multiplied by the number of FTEs in excess of 10 (1 divided by 15*$16,625) or a healthcare tax credit FTE reduction of $1,108. (See FIG. 1B)

18. Next the average wages of all employees are totaled and divided by the FTE calculated in step no. 12 and are used to calculate the second healthcare tax credit reduction. Again, the hours-based calculation results in a $31,000 average wage, while the days-based calculation results in a $28,000 average wage and the weeks method results in average wages of $25,000 (calculated in step no. 13 above, rounded to next lower $1,000). In the case study of FIG. 1, the hours method results in $6,000 over the $25,000 average wage limit resulting in a $3,990 credit reduction, the days method results in a $3,000 overage netting a $1,995 credit reduction while the weeks method has an average wage of $25,000 so no credit reduction is necessary. (See FIG. 1b)

19. The two reductions for each Hours-, Days- or Weeks-based calculation, respectively, are then totaled and subtracted from the gross tax credit of $16,625 to result in the net tax credit that is available to the taxpayer. The calculator tool performs these calculations and highlights the optimal tax credit when combining each of the permitted variables for each of the three hours, days and weeks methods. In this case, the weeks method is the optimal credit of $15,517, which is carried through to the sample Form 8941 produced by the invention. In this case, the small business owner was able to increase their tax credit by $2,882, only by using all variables permitted by tax law. (See FIG. 1D)

20. The healthcare tax credit calculator 10 then prompts the user or business owner to subtract the NET healthcare tax credit from the total amount of premiums paid and deductible under Section 162 and continue to deduct the remainder amount of employee benefit plan premiums on their tax return.

21. Using the above tax credit number and assuming the business owner is in the 28% federal tax bracket, the employer is already receiving a tax deduction on his premiums paid of $13,300 ($47,500*0.28). In this specific example, the Single User business owner will take their tax credit of $15,517, then deduct this amount from the $47,500, resulting in $34,200 that they will continue to be able to deduct as a business expense.

Prior to the end of a calendar year, using the healthcare tax credit tool, single-company users may prepare an annual estimated healthcare tax credit to assist in preparing a healthcare benefits budget for 2012. Users may also update their data in January 2012, when the companies have their 2011 W-2, hours, and premium paid information required to calculate a final 2011 small business healthcare tax credit. Single users will be eligible to process updates and print results through June 2012 for the 2011 tax year. The same would hold true for future tax years since the credit is available until 2017.

Multi-company users may also use the healthcare tax credit tool 10 to prepare unlimited estimated SBTC's to assist their clients in budgeting for 2012. Multi-company users may update this data in January 2012, when they have their client's 2011 W-2, hours, and premium paid information to calculate the final 2011 SBTC. Multi-users will also be provided an Excel-based template 30 (see FIG. 2) that multi-users may provide to their business clients for the clients to complete the data entry routine. The business client may complete and save the template 30, which may then be automatically uploaded to a web server. Upon upload of the data contained in template 30 from the client, the SBTC notifies the Multi-User that the Excel-based template information is saved to their account. The Multi-user may then login to the SBTC website to retrieve the calculation results and make any changes or corrections to the data and produce Form 8941 results.

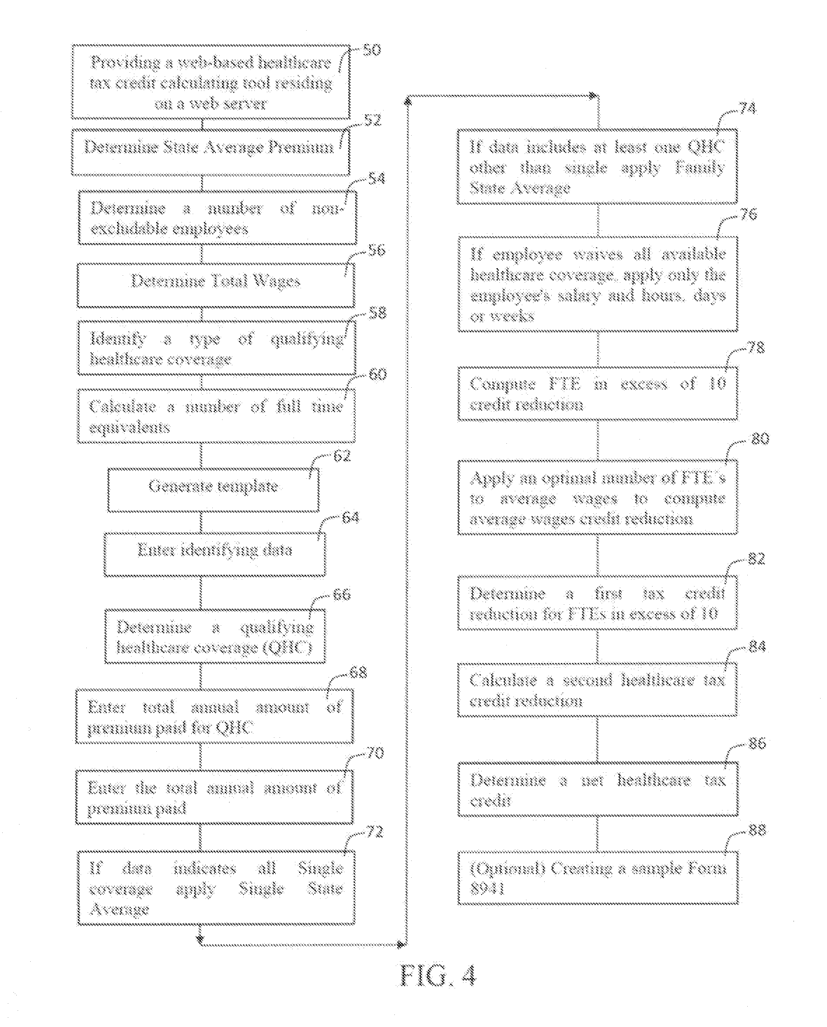

Referring next to FIG. 4, a system and method for determining a healthcare tax credit is disclosed. At step 50 the healthcare tax credit calculating tool is provided on a web server and is accessible from a remote device by a user or users over a wide area network. Then at step 52, the method proceeds to determine a State Average Premium, and at step 54 to determine a number of non-excludable employees from a plurality of employees; then at step 56 to determine a total of wages for a total number of non-excludable employees; (at step 58) identify at least one qualifying healthcare coverage applicable for each non-excludable employee; calculate a number of FTEs worked during a tax year by the non-excludable employees (step 60) and generate a template (step 62) configured for the number of FTEs. For each non-excludable employee enter identifying data associated with each non-excludable employee (step 64) and determine a qualifying healthcare coverage associated with the respective non-excludable employee (step 66). For each qualifying healthcare coverage that is identified for the non-excludable employee enter a total annual amount of qualifying healthcare coverage premium paid for the qualifying healthcare coverage during the tax year (step 68) and enter the total annual amount of qualifying healthcare coverage premium paid by the respective non-excludable employee during the tax year (step 70). If the non-excludable employee data indicates all Single coverage for all benefits, then apply a “Single State Average premium” for their specific state for where that specific non-excludable employee works (step 72). The method then proceeds to step 74, wherein if the non-excludable employee data includes at least one healthcare coverage other than single selected from one of non-excludable employee and child, non-excludable employee and children, non-excludable employee and spouse, or family, apply a “Family State Average Premium”. If in step 76 the respective non-excludable employee has waived all available employer-provided healthcare coverage, apply only the non-excludable employee's salary and hours, days or weeks in determining one of the two healthcare credit reductions, if any, compute an FTE in excess of 10 credit reduction; then in step 78 the calculator tool 10 computes an average wages credit reduction (step 80); calculate a first tax credit reduction for FTEs in excess of 10 (step 82); calculate a second healthcare tax credit reduction (step 84); and determine a net healthcare tax credit (step 86).

As noted above, embodiments within the scope of the present application include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. System for determining a healthcare tax credit, the system comprising;
a web-based healthcare tax credit calculating tool, residing on a web server and accessible by a plurality of users over a wide area network, the healthcare tax credit calculating tool configured to:
determine a State Average Premium determine a number of non-excludable employees from a plurality of employees;
determine a total of wages for a total number of non-excludable employees;
identify at least one qualifying healthcare coverage applicable for each non-excludable employee;
calculate a number of full time equivalents worked during a tax year by the non-excludable employees;
generate a template configured for the number of full time equivalents; and
for each non-excludable employee:
enter identifying data associated with each non-excludable employee
determine a qualifying healthcare coverage associated with the respective non-excludable employee;
for each qualifying healthcare coverage that is identified for the non-excludable employee:
a. enter a total annual amount of qualifying healthcare coverage premium paid for the qualifying healthcare coverage during the tax year; and
b. enter the total annual amount of qualifying healthcare coverage premium paid by the respective non-excludable employee during the tax year, if the non-excludable employee data indicates all Single coverage for all benefits then apply a “Single State Average premium” for their specific state for where that specific non-excludable employee works;
if the non-excludable employee data includes at least one healthcare coverage other than single selected from one of non-excludable employee and child, non-excludable employee and children, non-excludable employee and spouse, or family, apply a “Family State Average Premium”; or
if the respective non-excludable employee has waived all available employer-provided healthcare coverage, apply only the non-excludable employee's salary and hours, days or weeks in determining one of the two healthcare credit reductions, if any;
compute an FTE in excess of 10 credit reduction;
compute an average wages credit reduction;
calculate a first tax credit reduction for FTEs in excess of 10;
calculate a second healthcare tax credit reduction; and
determine a net healthcare tax credit.

2. The system of claim 1, wherein the State Average Premium is based on a state of the United States in which each non-excludable employee is employed.

3. The system of claim 1, wherein the qualifying healthcare coverage is one or more of the following qualifying healthcare coverages: medical, dental, vision, or extra qualifying coverage.

4. The system of claim 3, wherein the qualifying healthcare coverages further includes waived healthcare coverage.

5. The system of claim 1, wherein the number of full-time equivalents is calculated based on one of hours, days or weeks.

6. The system of claim 4, wherein the number of full-time equivalents is calculated based on one of hours, days or weeks.

7. The system of claim 1, wherein the total annual amount of qualifying healthcare coverage paid by the respective non-excludable employee includes each qualifying healthcare coverage associated with the respective employee of the plurality of qualifying healthcare coverages, including medical, dental, vision, extra qualifying coverage or waived healthcare coverage.

8. The system of claim 1, wherein the optimal number of FTEs is computed based on one of hours, days or weeks.

9. The system of claim 8, wherein the optimal number of FTEs is rounded down to lower whole number.

10. The system of claim 1, wherein the average wages credit reduction is computed by applying the optimal number of FTEs based on hours, days or weeks to average wages.

11. The system of claim 10, wherein the optimal number of FTEs is rounded down to the next 1,000.

12. The system of claim 1, wherein the second healthcare tax credit reduction comprises totaling average wages of all employees and dividing the total average wages by the number of FTEs.

13. The system of claim 1, wherein the net healthcare tax credit reduction by subtracting the first tax credit reduction and the second healthcare tax credit reduction from a gross healthcare tax credit.

14. The system of claim 1, wherein the healthcare tax credit calculating tool is further configured to create a sample form for ease in transference of data from the calculation to the proper entries in an active form.

15. The system of claim 14, wherein the healthcare tax credit calculating tool is further configured to transfer data to a corresponding data entry in one of lines 1 through 14 of an active form.

16. The system of claim 14, wherein the form is a Form 8941.

17. The system of claim 15, wherein the form is a Form 8941.

18. A method of determining a healthcare tax credit comprising:
providing a web-based healthcare tax credit calculating tool residing on a web server and accessible by a user or users over a wide area network;
determining a State Average Premium based on a state of the United States in which each employee is employed;
determining a number of non-excludable employees from a plurality of employees;
determining a total of wages or non-excludable employees;
identifying at least one type of qualifying healthcare coverage applicable for each non-excludable employee, from one or more of the following qualifying healthcare coverages: Medical, Dental, Vision and/or Extra Qualifying Coverage or waived coverage;
calculating a number of full time equivalents using hours, days or weeks worked during a tax year of non-excluded employees;
generating a template configured for the number of full time equivalents; and
for each non-excluded employee:
enter identifying data associated with each non-excluded employee;
determining a qualifying healthcare coverage or waived option associated with the respective non-excluded employee;
for each qualifying healthcare coverage that is identified for the non-excluded employee:
a. entering a total annual amount of premium paid for the qualifying healthcare coverage during the tax year; and
b. entering the total annual amount of premium paid by the respective non-excludable employee during the tax year, for each qualifying healthcare option associated with the respective employee;
if the non-excludable employee data indicates all Single coverage for all benefits then applying a “Single State Average premium” for their specific state for where that specific non-excludable employee works;
If the non-excludable employee data includes at least one qualifying healthcare coverage other than single selected from one of non-excludable employee and child, non-excludable employee and children, non-excludable employee and spouse, or family, applying a “Family State Average Premium”; or
if the respective non-excludable employee has waived all available employer-provided healthcare coverage, applying only the employee's salary and hours, days or weeks in determining one of the two healthcare credit reductions, if any;
applying an optimal number of FTEs using hours, days or weeks (rounded down to lower whole number) to compute an FTE in excess of 10 credit reduction;
applying an optimal number of FTE's using hours, days or weeks to average wages (rounded down to the next 1,000) to compute an average wages credit reduction;
determining a first tax credit reduction for FTEs in excess of 10;
calculate a second healthcare tax credit reduction comprising totaling average wages of all employees and dividing the total average wages by the number of FTEs; and
determining a net healthcare tax credit by subtracting the first tax credit reduction and the second healthcare tax credit reduction from a gross healthcare tax credit;
creating a sample Form 8941 for ease in transference of data from the calculation to the proper entries in Lines 1 through 14 of Form 8941.

19. A healthcare tax credit calculating tool, the tool configured to:
determine a State Average Premium determine a number of non-excludable employees from a plurality of employees;
determine a total of wages for a total number of non-excludable employees;
identify at least one qualifying healthcare coverage applicable for each non-excludable employee;
calculate a number of full time equivalents worked during a tax year by the non-excludable employees;
generate a template configured for the number of full time equivalents; and
for each non-excludable employee:
enter identifying data associated with each non-excludable employee;
determine a qualifying healthcare coverage associated with the respective non-excludable employee;
for each qualifying healthcare coverage that is identified for the non-excludable employee:
a. enter a total annual amount of qualifying healthcare coverage premium paid for the qualifying healthcare coverage during the tax year; and
b. enter the total annual amount of qualifying healthcare coverage premium paid by the respective non-excludable employee during the tax year, if the non-excludable employee data indicates all Single coverage for all benefits then apply a “Single State Average premium” for their specific state for where that specific non-excludable employee works;
If the non-excludable employee data includes at least one healthcare coverage other than single selected from one of non-excludable employee and child, non-excludable employee and children, non-excludable employee and spouse, or family, apply a “Family State Average Premium”; or
if the respective non-excludable employee has waived all available employer-provided healthcare coverage, apply only the non-excludable employee's salary and hours, days or weeks in determining one of the two healthcare credit reductions, if any;
compute an FTE in excess of 10 credit reduction;
compute an average wages credit reduction;
calculate a first tax credit reduction for FTEs in excess of 10;
calculate a second healthcare tax credit reduction; and
determine a net healthcare tax credit.

20. The tool of claim 19, wherein the State Average Premium is based on a state of the United States in which each non-excludable employee is employed; and wherein the qualifying healthcare coverage is one or more of the following qualifying healthcare coverages: medical, dental, vision, extra qualifying coverage or waived healthcare coverage; wherein the number of full-time equivalents is calculated based on one of hours, days or weeks; and the total annual amount of qualifying healthcare coverage paid by the respective non-excludable employee includes each qualifying healthcare coverage associated with the respective employee of the plurality of qualifying healthcare coverages, including medical, dental, vision, extra qualifying coverage or waived healthcare coverage; the optimal number of FTEs is computed based on one of hours, days or weeks, the optimal number of FTEs is rounded down to lower whole number; the average wages credit reduction is computed by applying the optimal number of FTEs based on hours, days or weeks to average wages.
